(19) United States
(12) Patent Application Publication
(10) Pub. No.: US 2009/0200257 A1
(43) Pub. Date: Aug. 13, 2009

(54) VENTED BABY BOTTLE

(75) Inventors: Bruce McKendry, Benicia, CA (US); Sung Lee, Sacramento, CA (US)

Correspondence Address: GREER, BURNS & CRAIN, 300 S WACKER DR, 25TH FLOOR, CHICAGO, IL, 60606, US

(73) Assignee: L. Jason Clute, Alamo, CA (US)

(21) Appl. No.: 12/030,629

(22) Filed: Feb. 13, 2008

(51) Int. Cl. A61J 9/04

(52) U.S. Cl. 215/11.5

(57) ABSTRACT

Baby bottles can have a single container, or two containers to create a space for thermal isolation, as selected by the user. The baby bottle can be vented to allow air to enter the bottle through a passageway as liquid is removed. A filter and one-way valve can be provided in the passageway. The passageway can be formed by radially aligning a vent opening in a top cap with a vent opening in a nipple flange, or by providing a channel in the top cap which is always in radial alignment with both the top cap vent opening and the flange vent opening.

### BACKGROUND OF THE INVENTION

Vented baby bottles such as those described in McKendry et al. U.S. Pat. No. 7,172,086 have an integral nipple and top cap. The present invention, made by the inventors of U.S. Pat. No. 7,172,086, is directed to various vented baby bottles having a nipple separate from the top cap. U.S. Pat. No. 7,172,086 is incorporated by reference in its entirety.

### SUMMARY OF THE INVENTION

In keeping with one aspect of the invention, a baby bottle has a generally barrel shaped container and a top cap having a top portion and a threaded side portion. The top portion has a circular central opening and a top cap vent opening between the circular central opening and the side portion.

The bottle has a nipple having a small opening at one end and a large opening at the other end. The nipple can be secured in the top portion circular central opening. A flange surrounds the large opening and extends outwardly from the large opening. The flange has a vent opening and a boss for securing a vent to the nipple in communication with the vent opening.

The top cap vent opening, flange vent opening and the vent create a passageway from the outside atmosphere to the inside of the container. A filter and a one-way valve can be provided in the passageway, if desired. The one-way valve opens to allow atmospheric air to enter the container, and closes to prevent liquid in the container from escaping from the container through the passageway.

The vent is typically a tube that extends from the top of the container to near the container bottom. When the tube is secured, the air enters the assembled baby bottle through the passageway, into the container.

There are other aspects of the invention, such as a circular channel in the top cap that maintains the passageway even if the top cap vent opening and vent opening are not aligned. The container can be double-walled for improved thermal stability, and a nipple insert can be used to better seat the nipple in the top cap.

### BRIEF DESCRIPTION OF THE DRAWINGS

The above mentioned and other features of this invention and the manner of obtaining them will become more apparent, and the invention itself will be best understood by reference to the following description of an embodiment of the invention taken in conjunction with the accompanying drawings, in which:

FIG. 1 is a cross-sectional diagram of one embodiment of the invention;

FIG. 2 is a cross-sectional diagram of a second embodiment of the present invention;

FIG. 3 is a cross-sectional diagram of a nipple used in the embodiments of FIGS. 1 and 2;

FIG. 4 is a perspective view of the nipple shown in FIG. 3;

FIG. 5 is a perspective view of the inside of the top cap used in the embodiments of FIGS. 1 and 2;

FIG. 6 is an expanded view of another embodiment of the present invention;

FIG. 7 is a cross-sectional diagram of the embodiment of FIG. 6, as assembled;

FIG. 8 is a cross-sectional diagram of another embodiment of the present invention;

FIGS. 9-12 are cross-sectional views of another embodiment of the present invention;

FIG. 13 is a plan view of the embodiment of FIGS. 9-12 shown assembled; and

FIG. 14 is a cross-sectional diagram of another embodiment of the present invention.

### DETAILED DESCRIPTION

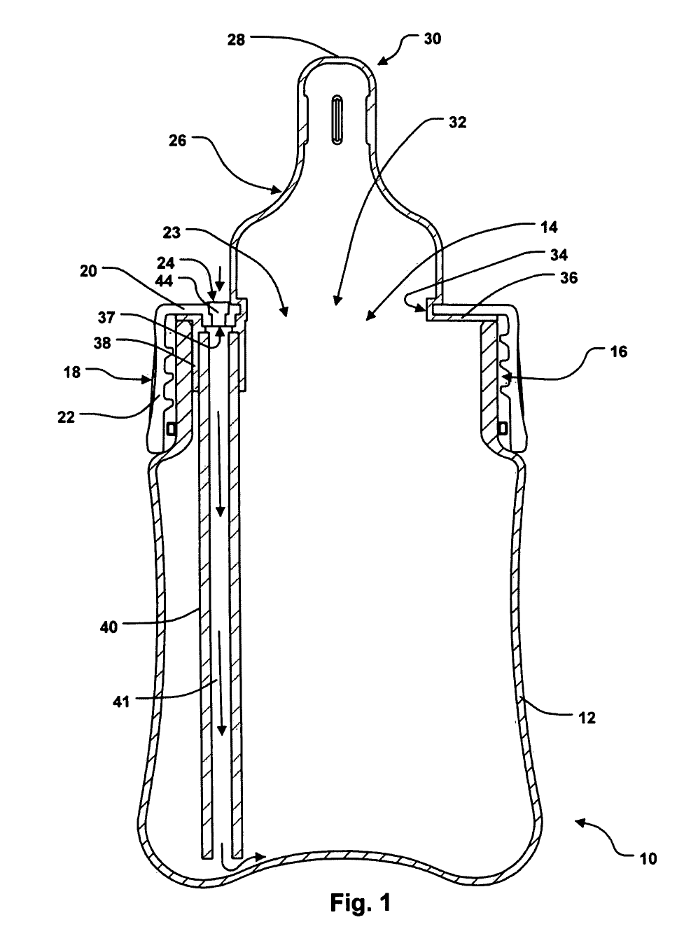

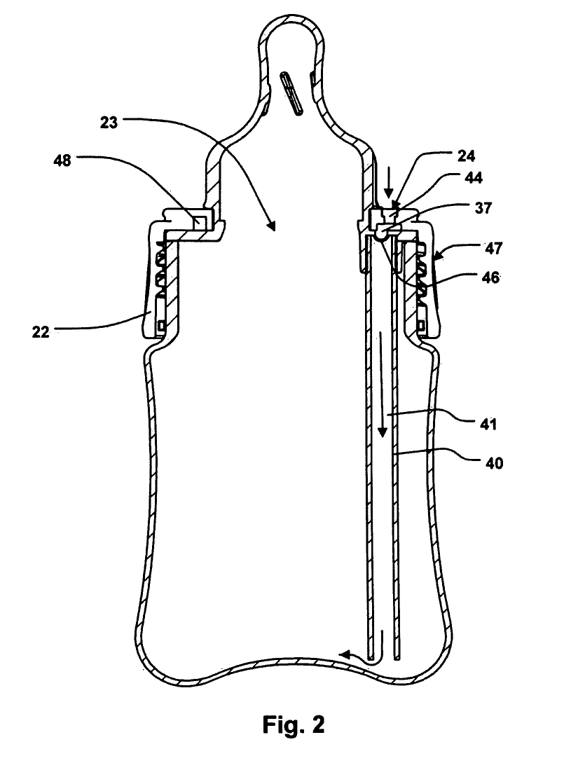

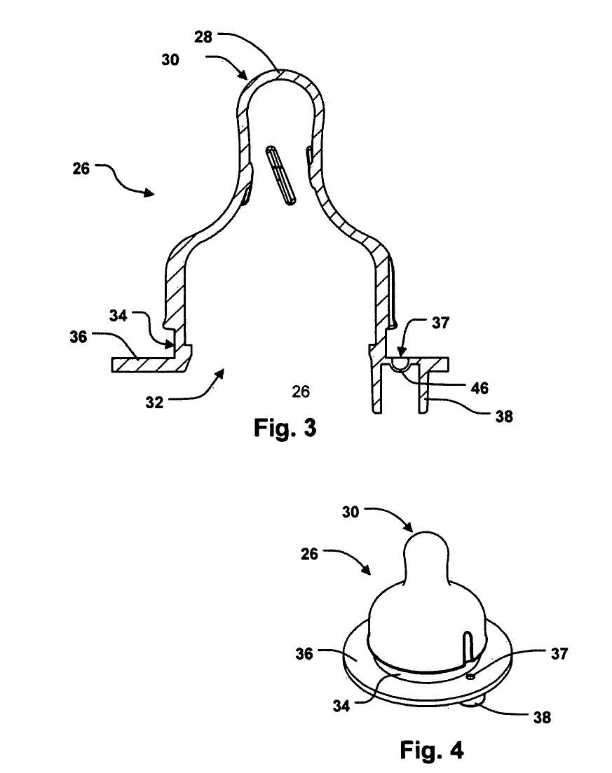

As seen in FIGS. 1-4, a baby bottle 10 includes a generally barrel shaped container 12 having a circular open top 14 and threads 16 surrounding the outside of the top 14. A top cap 18 in FIG. 1 (47 in FIG. 2) has a top portion 20 and a threaded side portion 22. The threaded side portion 22 can be secured to the container 12 by engaging the threads of the side portion with the threads of the open top, and can be removed easily from the container, as desired. The top portion 20 has a circular central opening 23 and a top cap vent opening 24 between the circular central opening 23 and the side portion 22.

A nipple 26, made of any suitable material such as silicone, TPE or latex, has a small opening 28 at an end 30, and a large opening 32 at its other end. The nipple can be secured in the top circular central opening 14 by providing an indented portion 34 near the large opening 32.

A flange 36 surrounds the large opening 32 and extends outwardly from the large opening 32. When the baby bottle is assembled, the flange extends below and inside the top portion 20.

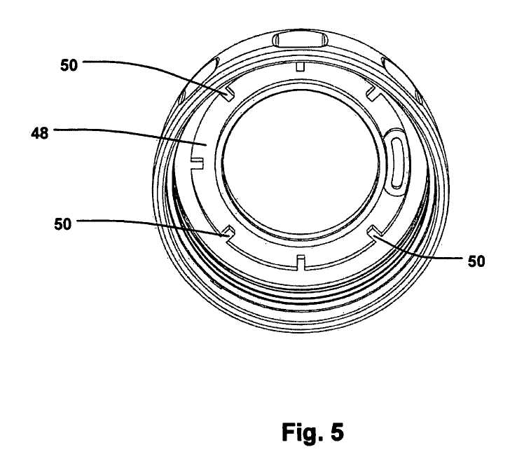

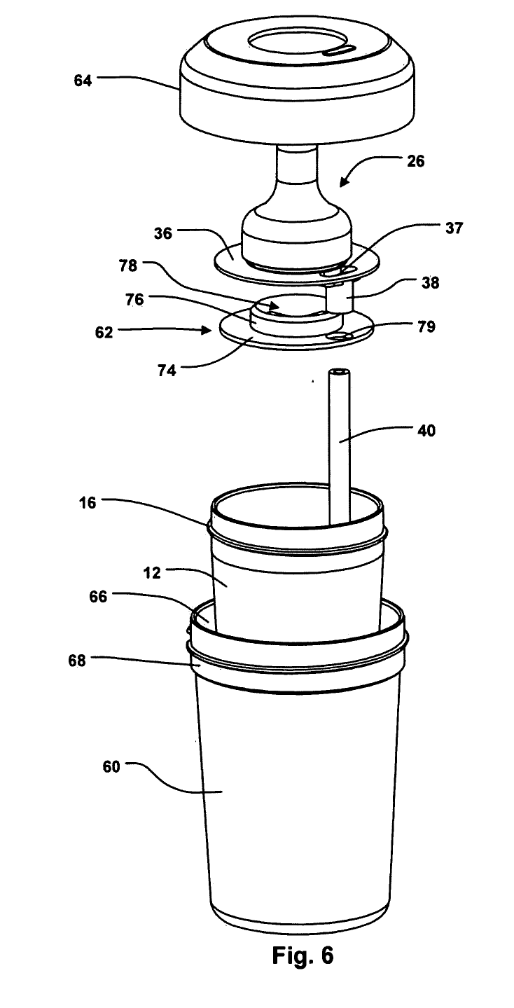

The flange 36 has a vent opening 37 (FIG. 4), and a circular boss 38 for securing a vent tube 40 (FIG. 6) to the nipple 26, in communication with the flange vent opening 37. The top cap vent opening 24, flange vent opening 37 and the tube 40 create a vent passageway 41 from an inside 42 of the container 12 to the outside atmosphere.

A filter 44 is provided in the passageway 41, in the top cap opening in FIG. 1, and a one-way valve 46 is also provided in the passageway. The one-way valve 46 can be a duckbill valve or the like that opens to allow atmospheric air to enter the container when liquid is removed through the opening 28. The valve closes to prevent liquid in the container from escaping from the container through the passageway.

The baby bottle 10 in FIG. 1 is assembled by inserting the end 30 of the nipple 26 through the large opening to the circular central opening of the top cap, and engaging the indentation 34 in the top cap. The top cap is then threaded to the container, with the nipple flange then secured between the container and the top portion. When so assembled, the top cap vent, flange vent opening and tube are in communication to form the passageway 41. In use, of course, the baby bottle is turned more or less upside down to draw milk or other liquid through the small opening 28. As the liquid is removed, air enters the baby bottle through the passageway into the container.

The filter 44 can be any suitable filter, such as a Pall filter. The filter 44 can be located in any suitable location in the passageway 41, including the top portion vent opening 24, as in FIG. 1. It could also be located in the nipple flange vent opening 36, or in the top, middle or bottom of the vent tube 40. Multiple filters could be used, if desired. It is preferable, though, that the filter be permeable to air and impermeable to liquid when wet and dry.

The indentation 34, which is formed in part by the flange 34, secures the nipple in the top portion 20. Among other things, the indentation 34 better secures the nipple in the top cap, even if the nipple is pushed down. The flange provides additional security in this regard.

In FIG. 1, the top cap vent opening and the flange vent opening are aligned when the baby bottle is assembled, to form the passageway. In the embodiment of FIG. 2, a top cap 47 has a circular channel 48 between the circular central opening 23 and the side portion 22. When the baby bottle is assembled, the top cap vent opening 24 is in communication with the circular channel 48, and the vent opening 37 in the flange 36 is also in communication with the circular channel 48. The circular channel 48 forms part of the passageway 41, so that the inside of the container 12 is vented irrespective of whether the vent opening 24 in the top cap is aligned with the vent opening 36 in the nipple flange when the baby bottle 10 is assembled.

As seen in FIG. 5, the channel 48 can have a plurality of spaced radial protrusions 50, which partially block the circular channel 48. If small amounts of liquid enter the circular channel 48 through the vent, the liquid is at least partially obstructed by the radial protrusions 50 and tends to accumulate between adjacent radial protrusions 50.

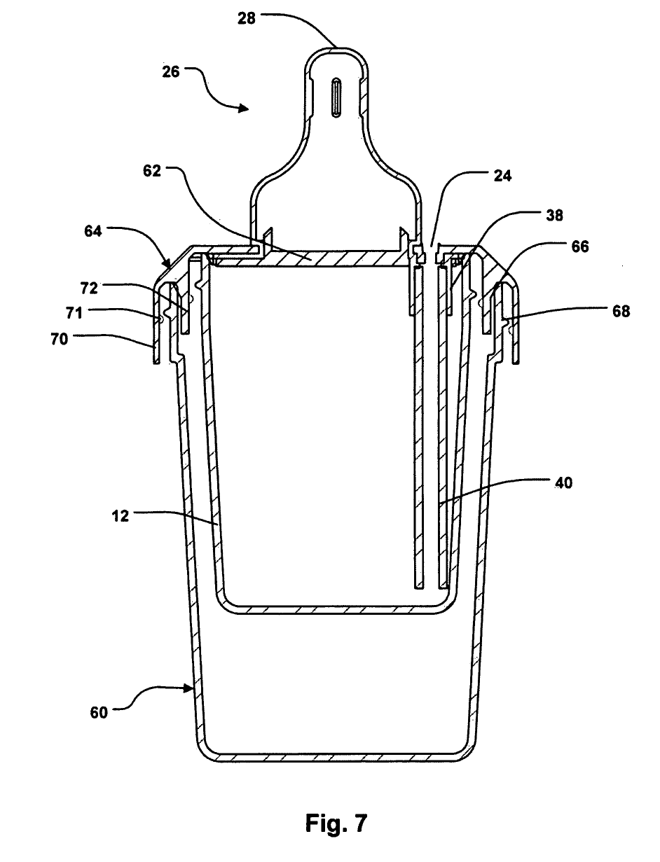

FIGS. 6 and 7 illustrate a double wall container configuration for use in the present invention. Reference numbers from the previous figures are used where appropriate. The bottles of FIGS. 6 and 7 include an outer bottle 60 and a nipple insert 62. A top cap 64 is similar to the top caps 18 and 47, but differs in some respects, as seen in FIG. 7.

The container 60 has an open end 66 and a threaded side portion 68. The top cap 64 includes a second side portion 70 having threads 71 that engage threads in the side portion 68. A downwardly extending flange 72 is provided to maintain a fixed space between the outer container 60 and the inner container 12.

The nipple insert 62 is located between the nipple flange 36 and the open end 14 of the container 12. The insert 62 has a flange 74, a circular cylindrical wall 76 around a central opening 78, and an opening 79. The wall 76 fits inside the nipple opening 32, and presses the nipple indentations 34. In this manner, the nipple is better locked in place in the cap with a frictional fit, preventing the nipple from being pulled out in an undesired manner. The nipple insert also improves the seal between the nipple and the top cap, to prevent leak of liquids when the bottle is turned upside down.

The opening 80 is aligned with the vent 38. The nipple insert can be a separate part or it can be over-molded or co-molded to the nipple, if preferred. The nipple insert can be attached to the nipple by welding, or with a mechanical latch mechanism.

Assembly of the bottle of FIGS. 6 and 7 is shown in FIG. 6, and is similar to the assembly of the embodiments of FIGS. 1-5. The outer bottle 60 is threaded into the top cap 64, and the insert 62 is placed in the assembly, before or after the nipple is installed into the top cap, and before the top cap is installed on the containers.

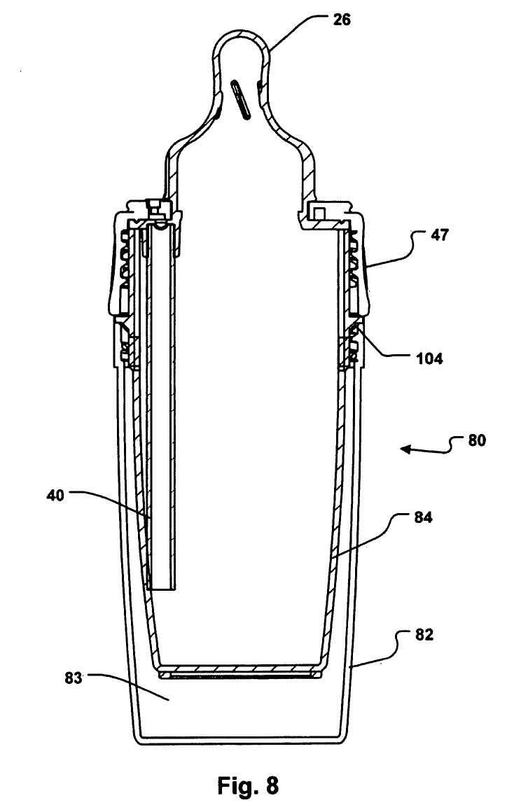

Another embodiment of the present invention is shown in FIG. 8, again using reference numbers from the previous figures where appropriate. A baby bottle 80 has an outer container 82 and an inner container 84 that form a space 83, a top cap 47 and a nipple 26. Though not shown, a filter and vent can be provided in this embodiment, as has been described with respect to other embodiments.

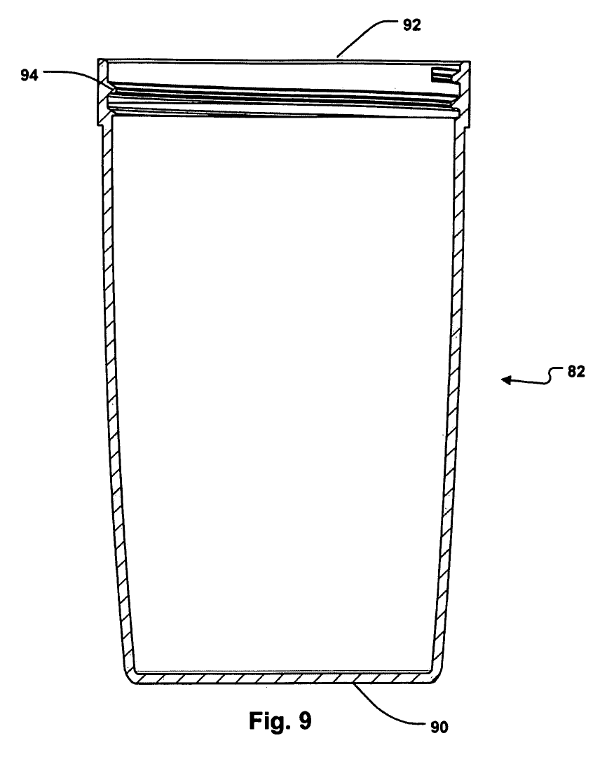

The outer container 82 has a generally barrel shape with a closed bottom 90 and an open top 92 having interior threads 94 (FIG. 9). The inner bottle 84 also has a generally barrel shaped configuration, though it is smaller than the outer container 82, to create the space 83 for thermal isolation of the inner container from the atmosphere. The space 83 can contain air, warm liquid or cold liquid, as desired.

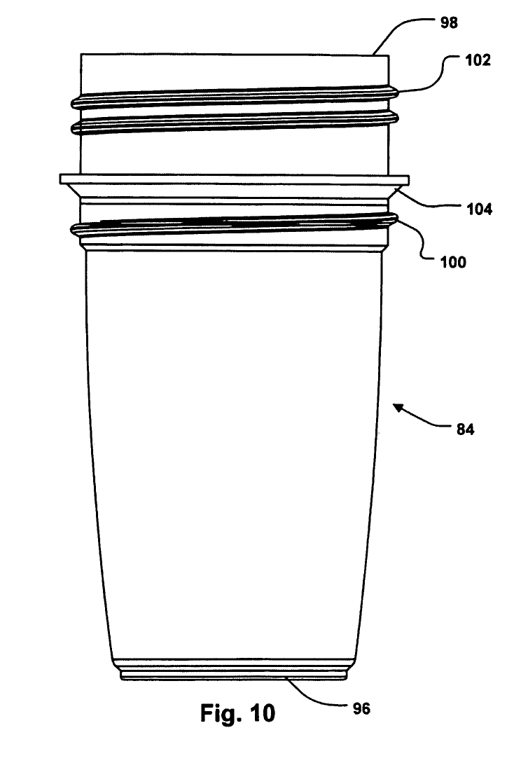

The inner container 84 has a bottom 96, an open top 98, outer threads 100 for engaging the threads 94 of the outer container 82, and outer threads 102 adjacent the open top 98, and above the outer threads 100, as seen in FIG. 10. The container 84 also has a lip 104 that seals the space between the containers 82, 84, when the outer container 82 is fully threaded onto the inner container 84, as in FIG. 8.

The nipple 26 is secured in the top cap 47 in the manner previously described, and the top cap 47 is threadedly secured to the inner container 84 by using the threads 102. In this manner, the top cap 47 and the outer container 84 are independently secured to the inner container 84 and the outer container 82.

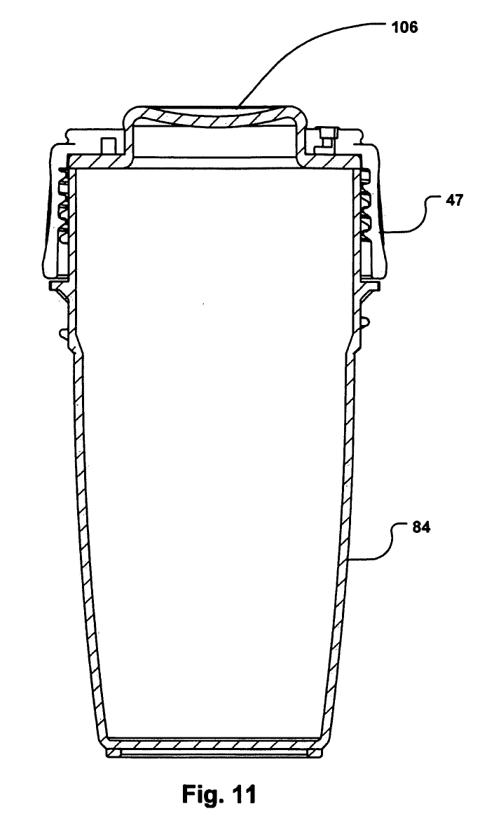

Milk or other liquid or solid materials can be stored in the inner container 84 for transportation using the sealing cap 106 shown in FIG. 11. The sealing cap 106 is preferably secured in the top cap 47 in the same manner as the nipple 26, but the sealing cap 106 does not have an opening to release the milk. However, the outer container 82 can still be placed on or taken off of the inner container 84, as desired, without removing the top cap 86.

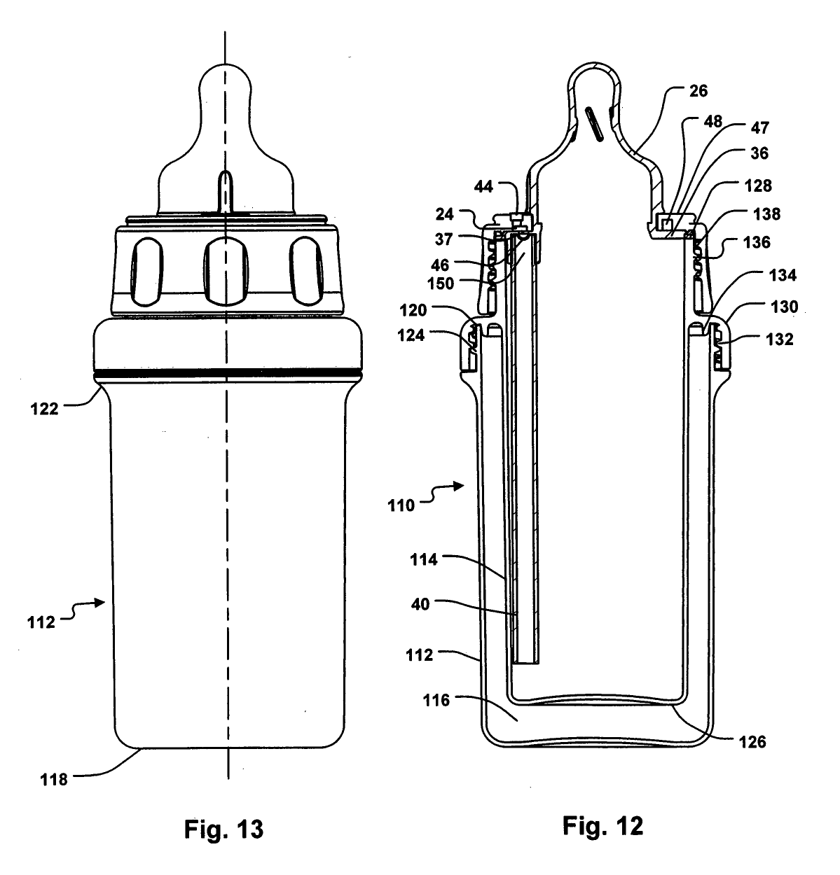

Another embodiment of the present invention is shown in FIG. 12. The embodiment of FIG. 12 is similar to the embodiment just described, but includes a filter and vent, as previously described. A baby bottle 110 includes an outer container 112 and an inner container 114, which when assembled together, create a space 116 to thermally isolate the contents of the inner bottle 114 from the atmosphere.

The outer container 112 can be made by any suitable manner such as blow molding. The inner container 114 can also be made in any suitable manner, such as injection molding.

The container 112 has a bottom 118, an open top 120, a sealing lip 122 and exterior threads 124 (FIG. 13). The inner container 114 has a bottom 126, an open top 128, and a flange 130 having interior threads 132 for engagement with the threads 124 of the outer container 112. A sealing lip 134 is provided radially opposite the threads 132 when the outer bottle is secured, as seen in FIG. 12. The sealing lip 134 and the sealing lip 122 seal the space 116.

The inner container 114 also has outer threads 136 for engagement with inner threads 138 of the top cap 47. The nipple 26 is installed in the top cap 47 in the manner previously described. In addition, the top cap 47 can have the channel 48, the vent opening 24 with the filter, and the vent tube.

The embodiments of FIGS. 8, 12 and 13 are particularly useful with young infants, because the temperature in the inner container is better maintained throughout a feeding.

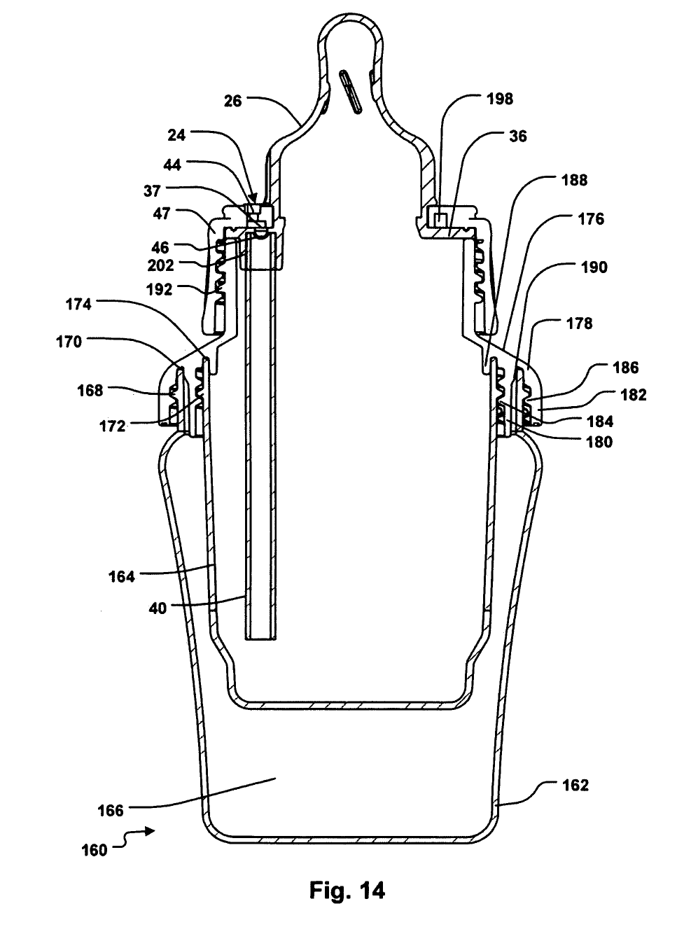

Yet another embodiment of the present invention is shown in FIGS. 14 and 15. In this embodiment, the inner and outer containers in can both be used for feeding. This can be helpful with older infants, because the outer container can hold a larger serving.

The baby bottle 160 includes an outer container 162 and inner container 164 that form a thermal isolation space 166 between the two containers. The outer container 162 has outer threads 168 adjacent an open top 170, and the inner container 164 has outer threads 172 adjacent a top opening 174. The containers 164 and 162 are secured to each other by an adapter 176 which includes a flange 178 having an inner wall 180 and an outer wall 182. The inner wall 180 has inside threads 184, and the outer wall 182 has inside threads 186. A sealing lip 188 is also provided, for sealing the contents of the inner container 164. The inner wall 180 has an extension 190 which seals the contents of the outer container 162 in the space 166.

The adapter 176 also has outer threads 192 at the end of the member 176 opposite the flange 182. The threads 192 accept the interior threads of a cap 194, in which a nipple 26 is secured. The cap 47 can also have a channel 198, and a filter 24 and a vent 202, as previously described.

With this embodiment, the outer container 162 is not needed, and can be removed in favor of the inner container 164. On the other hand, more milk or other substances can be given to a baby by removing the inner container 164 and filling the outer container 162 with nutritious substances.

While the principles of the invention have been described above in connection with specific apparatus and applications, it is to be understood that this description is made only by way of example and not as a limitation on the scope of the invention.

What is claimed is:

1. A baby bottle comprising:
a generally barrel shaped container having a circular open top and threads surrounding the outside of the open top;
a top cap having a top portion and a threaded side portion, the threaded side portion being capable of removably securing the top cap to the container,
the top portion having a circular central opening and a top cap vent opening between the circular central opening and the side portion,
a nipple having
a small opening at one end and a large opening at the other end,
means for securing the nipple in the top portion circular central opening,
a flange surrounding the large opening and extending outwardly from the large opening,
a vent opening in the flange,
means for securing a tube to the nipple in communication with the vent opening,
the top cap vent opening, flange vent opening and the tube creating a passageway from the inside of the container to the outside atmosphere,
at least one filter in the passageway,
at least one one-way valve in the passageway,
the one-way valve opening to allow atmospheric air to enter the container and closing to prevent liquid in the container from escaping from the container through the passageway,
whereby when the tube is secured to the nipple, the nipple is secured in the top cap, and the top cap is secured to the container, with the nipple flange then secured between the container and the top portion, then the top cap vent opening, the flange vent opening, and tube are in communication to form the passageway, and the inside of the container is vented for entry of air into the container as liquid is removed, the air entering the assembled baby bottle through the passageway, into the container.

2. The baby bottle of claim 1, wherein the top cap vent opening and the flange vent opening are keyed so as to be aligned when the baby bottle is assembled.

3. The baby bottle of claim 1, wherein the top cap has a circular channel between the circular central opening and the side portion, the top cap vent opening being in communication with the circular channel, and the vent opening in the flange also being in communication with the circular channel, the circular channel forming part of the passageway,
whereby the inside of the container is vented, irrespective of whether the vent opening in the top cap is aligned with the vent opening in the nipple flange when the baby bottle is assembled.

4. The baby bottle of claim 3 comprising a plurality of spaced radial protrusions in the circular channel, the radial protrusions partially blocking the circular channel,
whereby liquid that enters the circular channel is at least partially obstructed by the radial protrusions and tends to accumulate between adjacent radial protrusions.

5. The baby bottle of claim 1, comprising a second container having a volume larger than the volume of the first container,
the second container having a generally barrel shape having a second circular open top and second threads surrounding the outside of the second open top,
the top cap having a second side portion having threads that engage the second threads in the second container.

6. The baby bottle of claim 5, wherein the top cap has a downward extending flange between the second container and the container, the downward extension flange being provided to maintain a fixed space between the second container and the container.

7. The baby bottle of claim 5, wherein the means for securing the nipple includes a nipple insert between the nipple flange and the open end of the container.

8. The baby bottle of claim 7, wherein the nipple insert has a flange, a circular cylindrical wall around a central opening, and a second opening aligned with the vent, the cylindrical wall fitting inside the large opening.

9. A baby bottle comprising:
a container having a bottom, an open top, first outer threads for engaging threads of a second container, the first outer threads being between the bottom and the open top, second outer threads adjacent the open top between the open top and the first outer threads for threaded engagement with a top cap, and a sealing lip between the first outer threads and the second outer threads, and
a cap for substantially sealing the open top.

10. The baby bottle of claim 9, comprising a second container, the container being smaller than the second container to create a space for thermal isolation between the container and the atmosphere, wherein the space can contain air, warm liquid or cold liquid,
the second container being threadedly secured to the container using the first outer threads, an open top of the second container abutting the sealing lip of the container to create a seal.

11. The baby bottle of claim 9, wherein the cap is an assembly having a threaded top cap and a storage cap in a central opening in the top cap.

12. The baby bottle of claim 9, wherein the cap is an assembly having a threaded top cap and a nipple in a central opening of the top cap.

13. The baby bottle of claim 12, comprising:
means for securing a tube to a flange in the nipple in communication with a vent opening in the top cap,
the top cap vent opening, a flange vent opening and the tube creating a passageway from the inside of the container to the outside atmosphere.

14. The baby bottle of claim 13 comprising at least one filter in the passageway.

15. The baby bottle of claim 14 comprising
at least one one-way valve in the passageway,
the one-way valve opening to allow atmospheric air to enter the container and closing to prevent liquid in the container from escaping from the container through the passageway.

16. The baby bottle of claim 13 comprising at least one one-way valve in the passageway, the one-way valve opening to allow atmospheric air to enter the container and closing to prevent liquid in the container from escaping from the container through the passageway.

17. A baby bottle comprising:
a container having a bottom, an open top, first outer threads adjacent the open top, and a flange between the bottom and the first threads, the flange extending outwardly from the container and downwardly towards the container bottom, and having threads on an inside surface of the flange,
a second container larger than the container, the second container having a bottom and open top and second outer threads for engaging the threads of the flange, and
a top cap for substantially sealing the open top of the container.

18. The baby bottle of claim 17, comprising:
a nipple in the top cap, the nipple having a flange,
means for securing a tube to the nipple flange in communication with a vent opening in the nipple flange and a vent opening in the top cap,
the top cap vent opening, the flange vent opening and the tube creating a passageway from the inside of the container to the outside atmosphere.

19. The baby bottle of claim 18 comprising at least one filter in the passageway.

20. The baby bottle of claim 19 comprising
at least one one-way valve in the passageway,
the one-way valve opening to allow atmospheric air to enter the container and closing to prevent liquid in the container from escaping from the container through the passageway.

21. The baby bottle of claim 18 comprising at least one one-way valve in the passageway,
the one-way valve opening to allow atmospheric air to enter the container and closing to prevent liquid in the container from escaping from the container through the passageway.

22. A baby bottle comprising:
an inner container and an outer container,
the inner container and outer container forming a thermal isolation space between the two containers,
the outer container having first outer threads adjacent a first open top, and the inner container having second outer threads adjacent a second open top,
an adapter for securing the outer container and inner container in spaced relation to each other, the adapter having a flange, an inner wall and an outer wall, the inner wall having inside threads and the outer wall having inside threads,
the adapter having outer threads at the end of the adapter opposite the flange,
a cap to which a nipple having a flange is secured, the cap having cap threads that threadedly engage the outer threads of the adapter,
whereby milk or other substances can be placed in the inner container, with or without the outer container, or the liquid or other substance can be placed in the outer container, with or without the inner container, to provide a larger volume for containment of the liquid or other substance.

23. The baby bottle of claim 22, comprising:
means for securing a tube to the nipple flange in communication with a vent opening in the top cap,
the top cap vent opening, a vent opening in the nipple flange and the tube creating a passageway from the inside of the container to the outside atmosphere.

24. The baby bottle of claim 23 comprising at least one filter in the passageway.

25. The baby bottle of claim 24 comprising
at least one one-way valve in the passageway,
the one-way valve opening to allow atmospheric air to enter the container and closing to prevent liquid in the container from escaping from the container through the passageway.

26. The baby bottle of claim 23 comprising
at least one one-way valve in the passageway,
the one-way valve opening to allow atmospheric air to enter the container and closing to prevent liquid in the container from escaping from the container through the passageway.
